(19) United States
(12) Patent Application Publication
(10) Pub. No.: US 2026/0259174 A1
(43) Pub. Date: Sep. 3, 2026

(54) DEVICE FOR DETECTION OF BTEX USING A POLYMER WITH FLUOROBENZYL GROUPS

(71) Applicants: TotalEnergies OneTech, COURBEVOIE (FR); Centre national de la recherche scientifique, Paris (FR); UNIVERSITE MARIE ET LOUIS PASTEUR, BESANÇON (FR)

(72) Inventors: Frédéric CHERIOUX, LARNOD (FR); Jean-Michel FRIEDT, BESANCON (FR); Vincent LUZET, PAU CEDEX (FR); Jean-Sébastien DEHEZ, PAU CEDEX (FR); Nathalie NIEF, LESCAR (FR)

(73) Assignees: TotalEnergies OneTech, COURBEVOIE (FR); Centre national de la recherche scientifique, Paris (FR); UNIVERSITE MARIE ET LOUIS PASTEUR, BESANÇON (FR)

(21) Appl. No.: 19/159,564

(22) PCT Filed: Mar. 2, 2023
(86) PCT No.: PCT/IB2023/000096

§ 371 Date: Aug. 25, 2025

(51) Int. Cl. G01N 29/02; G01N 21/59; G01N 29/036

(52) U.S. Cl. CPC G01N 29/022; G01N 29/036; G01N 2021/5903; G01N 2291/0255

(57) ABSTRACT

A device for detection of a BTEX component in a liquid or gaseous phase including a sensor for producing a signal representative of the detection of the BTEX component. The sensor includes a layer of a material intended to be in physical contact with the phase, the material comprising a polymer having substituted benzyl group which is repeated more than ten times. The benzyl group comprising fluorine atoms and, at most, two other components selected among hydrogen, halogen atoms, and C₁ to C₂ alkyl groups.

### CROSS REFERENCE TO RELATED APPLICATIONS

The present application is a U.S. National Phase Application under 35 U.S.C. § 371 of International Patent Application No. PCT/IB2023/000096 filed Mar. 2, 2023. The entire contents of which are hereby incorporated by reference.

### FIELD

The present invention deals with a device for detection of a BTEX component in a liquid or gaseous phase comprising a sensor adapted to produce a signal representative of the detection.

The invention also deals with a method for detecting a BTEX component using such a device.

### BACKGROUND

In the oil and petrochemical industries, BTEX refers to benzene, toluene, ethylbenzene, and xylene isomers, these aromatic hydrocarbons being considered alone or in mixtures. BTEX are usually in an aqueous phase. Detecting these chemical components is important for managing potentially contaminated soil and groundwater in and from industrial sites. BTEX may also be in a gaseous phase such as a contaminated atmosphere.

Today, existing solutions are directly deployed in monitoring wells, which have to be drilled. Occasionally, optical measurements (for example using ultra-violet, around 260 nm) of BTEX are performed. However, these direct solutions are costly and may suffer calibration issues, and drift due to exposure to contaminants. Also, they may expose operators to the contaminants.

More traditional, indirect, solutions require sampling by pumping groundwater to the surface. The BTEX concentrations are then determined either on site using portable analyzers, or later in a laboratory remote from the industrial site. However, these solutions introduce a large delay between sampling and measuring, and a loss of contaminants may occur during the transport of samples.

To our knowledge, there exists no permanent solution for this type of detection. Of course, various techniques are known in order to detect all kinds of components, but none has been able to address the issue of detecting chemical components, such as BTEX, in a liquid phase, such as a water saturated soil, or a gaseous phase, such as the atmosphere.

### SUMMARY

An aim of the invention is to solve or improve the above issues, in particular in order to allow detection of BTEX components with good sensitivity and selectivity, in particular in a sub-surface liquid phase that is difficult to access or in an atmosphere.

To this end, the invention proposes a device for detection of a BTEX component in a liquid or gaseous phase comprising a sensor adapted for producing a signal representative of the detection, the sensor comprising at least one layer of a material sensitive to the BTEX component and intended to be in physical contact with the phase, the material comprising a polymer including a sequence of the following formula:

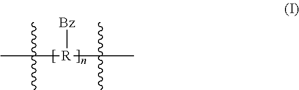

wherein:
R-Bz is a unit repeated n times,
n is an integer greater than 10,
R is an organic group, and
Bz is an at least partly substituted benzyl group of the following formula:

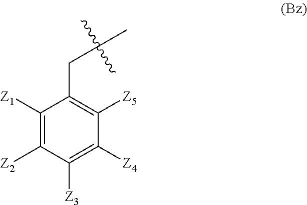

wherein at least three independently selected ones among Z1, Z2, Z3, Z4 and Z5 are fluorine atoms, and the at most two others among Z1, Z2, Z3, Z4 and Z5 are selected among hydrogen, halogen atoms, and C₁ to C₂ alkyl groups.

In other embodiments, the device comprises one or several of the following features, taken in isolation or any technically feasible combination:
Z1, Z2, Z3, Z4 and Z5 are fluorine atoms;
the unit R-Bz has the following formula:

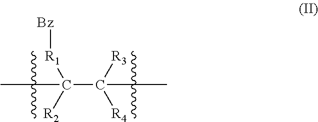

wherein R1 is selected from the groups —CH₂—, —C₂H₄— and —C(O)O—, and each of R2, R3, R4 is independently chosen from hydrogen and C₁ to C₆ alkyl groups;
   R1 is —C(O)O—;
   R2 is —CH₃, and R3 and R4 are hydrogen;
   R2, R3 and R4 are hydrogen;
   the layer extends on a surface of the sensor and has a thickness perpendicularly to the surface, said thickness being comprised between 600 and 1000 nm;
   the sensor is a bulk acoustic wave sensor or a surface plasmon resonance sensor;
   the sensor is a surface acoustic wave sensor;
   the sensor comprises:
      a piezoelectric substrate comprising lithium tantalate, the substrate having a surface extending in a longitudinal direction,
      an interdigitated transducer located on the surface for receiving an electrical signal and sending an electrical response signal, the interdigitated transducer being adapted to convert the signal into surface acoustic waves in the longitudinal direction,
      at least a first mirror located on the surface and adapted for receiving a first part of the surface acoustic waves and producing a first echo towards the interdigitated transducer by mechanical reflection and/or re-emission of said first part of the surface acoustic waves, and
      at least a first layer comprising the polymer, the first layer being located on the surface between the transducer and the first mirror, and being adapted for interacting with the BTEX component so as to modify a travel speed of the first echo along said first layer,
      the transducer being adapted to convert the first echo into at least part of the response signal;
   the sensor further comprises:
      a second mirror located on the surface and adapted for receiving a second part of the surface acoustic waves and producing a second echo towards the transducer by mechanical reflection or re-emission of said second part of the surface acoustic waves,
      a second layer of a metal and/or a polymer, located on the surface between the transducer and the second mirror,
      a third mirror located on the surface and adapted for receiving a third part of the surface acoustic waves and producing a third echo towards the transducer by mechanical reflection and/or re-emission of said third part of the surface acoustic waves, and
      a third layer of a metal and/or a polymer, located on the surface between the second mirror and the third mirror,
      the transducer being adapted for receiving the second echo and the third echo and converting the second echo and the third echo into at least part of the response signal;
   the transducer and the first mirror comprise aluminum;
   the transducer and/or the first mirror is/are interdigitated transducer(s) having split-fingers extending in a transverse direction perpendicular to the longitudinal direction; and
   the transducer and/or the first mirror is/are interdigitated transducer(s) with sine shaped apodization.

The invention also proposes a method for detecting a BTEX component in a liquid or gaseous phase, comprising the following steps:
obtaining a device as described above,
allowing physical contact between said layer and the phase,
producing a signal representative of the detection, and
receiving and interpreting the signal.

### BRIEF DESCRIPTION OF THE DRAWINGS

The invention will be better understood, based on the following description, given solely as an example and with reference to the appended drawings, in which:

FIG. 1 is a schematic view of a device according to the invention,

FIG. 2 is a schematic view of how a polymer present in the device shown in FIG. 1 interacts with a BTEX component in the opinion of the inventors,

FIG. 3 is a schematic perspective view of a practical installation including a device as shown in FIG. 1,

FIG. 4 is a schematic front view of a sensor of the installation shown in FIG. 3,

FIG. 5 is a schematic front view of a pattern of the interdigitated transducer or the mirrors of the sensor shown in FIGS. 3 and 4,

FIGS. 6 and 7 are schematic front views of two patterns forming variants of the pattern shown in FIG. 5, and

FIG. 8 is a diagram showing a measured delay, expressed as a phase difference, between the second echo and the first echo (serving as reference), and between the third echo and the first echo obtained with the sensor shown in FIGS. 3 and 4.

### DETAILED DESCRIPTION

### Device and Polymer

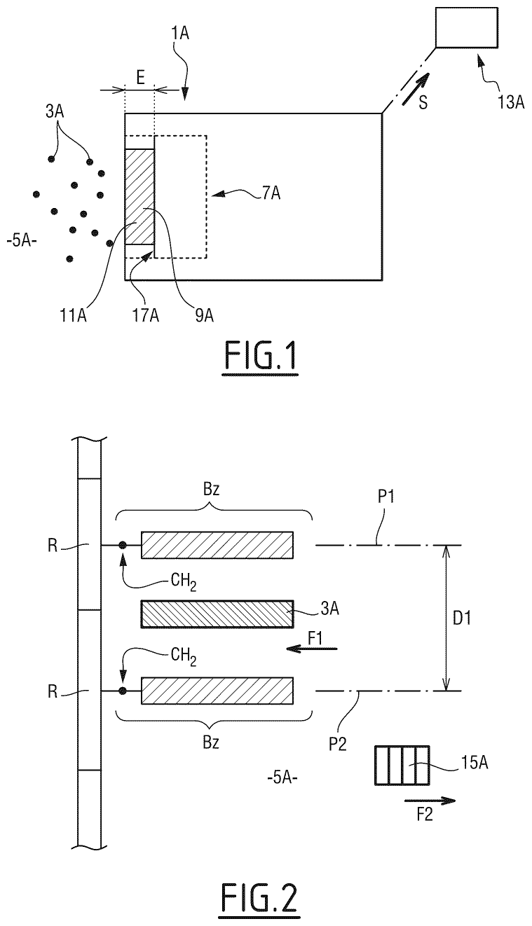

A device 1A according to the invention will now be described with reference to FIG. 1.

The device 1A is adapted for detecting a BTEX component 3A as defined above, in a liquid or gaseous phase 5A.

The device 1A comprises a sensor 7A adapted to produce a signal S representative of the detection, the sensor 7A comprising at least one layer 9A of a material 11A sensitive to the BTEX component 3A and intended to be in physical contact with the phase 5A.

The sensor 7A is advantageously connected, by wire or wirelessly, to a distant system 13A adapted for receiving the signal S. The sensor 7A may be of different types.

For example, the sensor 7A is a surface acoustic wave (SAW) sensor.

In another embodiment, the sensor 7A is a bulk acoustic wave (BAW) sensor.

As a variant, the sensor 7A is a surface plasmon resonance (SPR) sensor.

For example, the phase 5A is a liquid, such as subsurface water, or a gas, such as an atmosphere.

The material 11A comprises a polymer including a sequence of the following formula (I):

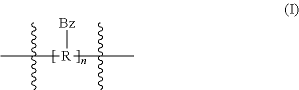

wherein:
R-Bz is a unit repeated n times,
n is an integer greater than 10,
R is an organic group, and
Bz is an at least partly substituted benzyl group.

Each of the groups Bz has the following formula (Bz):

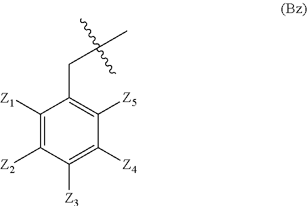

wherein at least three independently selected ones among Z1, Z2, Z3, Z4 and Z5 are fluorine atoms, and the at most two others among Z1, Z2, Z3, Z4 and Z5 are independently selected among hydrogen, halogen atoms, and C1 to C2 alkyl groups.

For example, the polymer is formed by said sequence, with hydrogen or an organic group, for example an alkyl group, at both extremities of the sequence.

For example, the material 11A comprises at least 90 wt %, preferably at least 99 wt %, of the polymer based on the total weight of the material 11A.

The polymer is adapted for selectively interacting with the BTEX component 3A, and for modifying the propagation speed of SAW and BAW in the corresponding sensors, or an optical index in an SPR sensor.

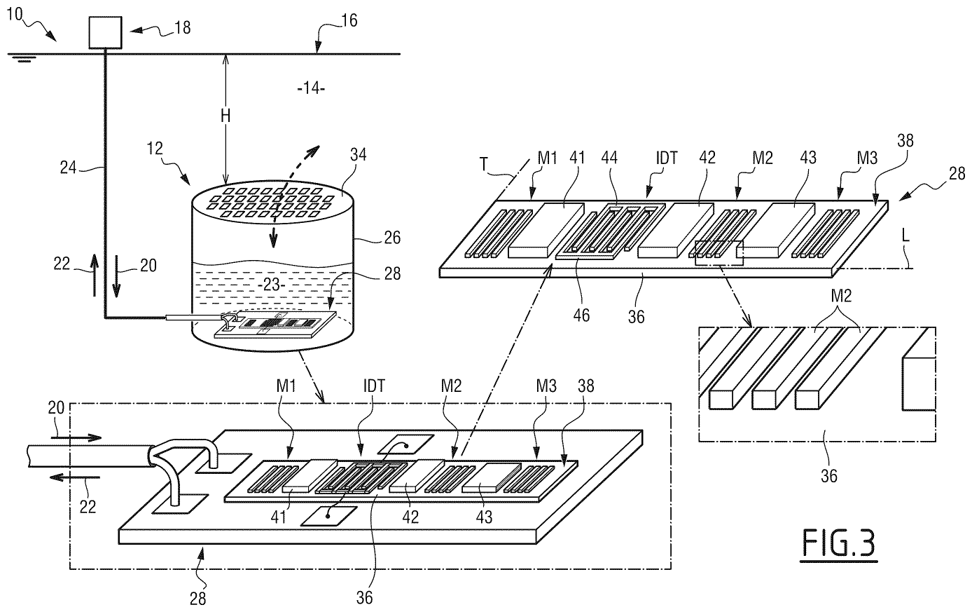

Without being bound by a technical or scientific explanation, the inventors believe that, as shown in FIG. 2, pairs of the groups Bz, in which the two groups are close enough to each other, are able to interact with an aromatic group of the BTEX component 3A by π-π stacking in order to retain the BTEX component. This provides selectivity to the sensor 7A.

For example, the two groups Bz involved in the π-π stacking extend in planes P1, P2, preferably parallel to each other, and are separated by a distance D1 comprised between 0.30 and 0.80 nm, preferably between 0.50 and 0.60 nm.

In case the phase 5A is aqueous, the inventors also think that the at least three fluorine atoms present in each of the groups Bz provide the polymer with a hydrophobic character that helps attracting (arrow F1) the BTEX component 3A by pushing (arrow F2) water molecules 15A away. This provides sensitivity to the sensor 7A.

For example, the sensitive layer 9A has a contact angle (characterizing its hydrophobicity) of at least 110°.

It is also believed that the —CH2- group, by which each group Bz connects to an R group in the polymer, advantageously provides solubility to the polymer, which allows depositing a thin layer of the polymer, for example by spin coating.

The layer 9A for example extends on a surface 17A of the sensor 7A and has a thickness E perpendicularly to the surface 17A, said thickness E being advantageously comprised between 600 and 1000 nm.

For example, n is comprised between 10 and 132.

In a particular embodiment, all the groups Bz in the n units have the same Z1, Z2, Z3, Z4 and Z5. As a variant, some of the groups Bz may differ from each other.

By “halogen”, it is meant a fluorine, chlorine, bromine or iodine atom.

Preferably, at least four of Z1, Z2, Z3, Z4 and Z5 are fluorine atoms.

More preferably, Z1, Z2, Z3, Z4, and Z5 are fluorine atoms. In other words, the groups Bz are 2,3,4,5,6-pentafluorobenzyl.

For example, independently of the formula (Bz), the unit R-Bz has the following formula (II):

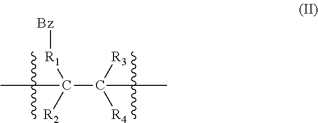

wherein R1 is selected from the groups —CH2-, —C2H4- and —C(O)O—, with a preference for —C(O)O—, and each of R2, R3, R4 is independently chosen from hydrogen and C₁ to C₆, preferably C₁ to C₂, alkyl groups.

Preferably, R1 is —C(O)O—.

In a particular embodiment, R2 is —CH3, and R3 and R4 are hydrogen. The polymer is then preferably poly(2,3,4,5,6-pentafluorobenzyl methacrylate), or pPFBMA, of the following formula (III):

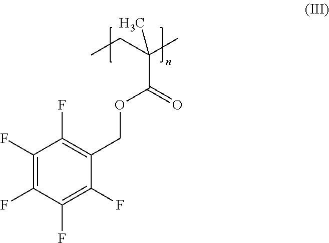

In another particular embodiment, R2, R3 and R4 are hydrogen. Preferably, the polymer is then poly(2,3,4,5,6-pentafluorobenzyl acrylate), or pPFBA, of the following formula (IV):

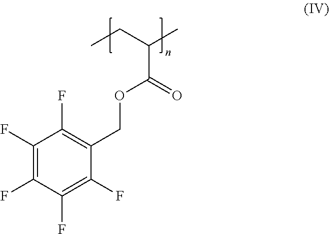

Example of an Installation with a SAW Sensor

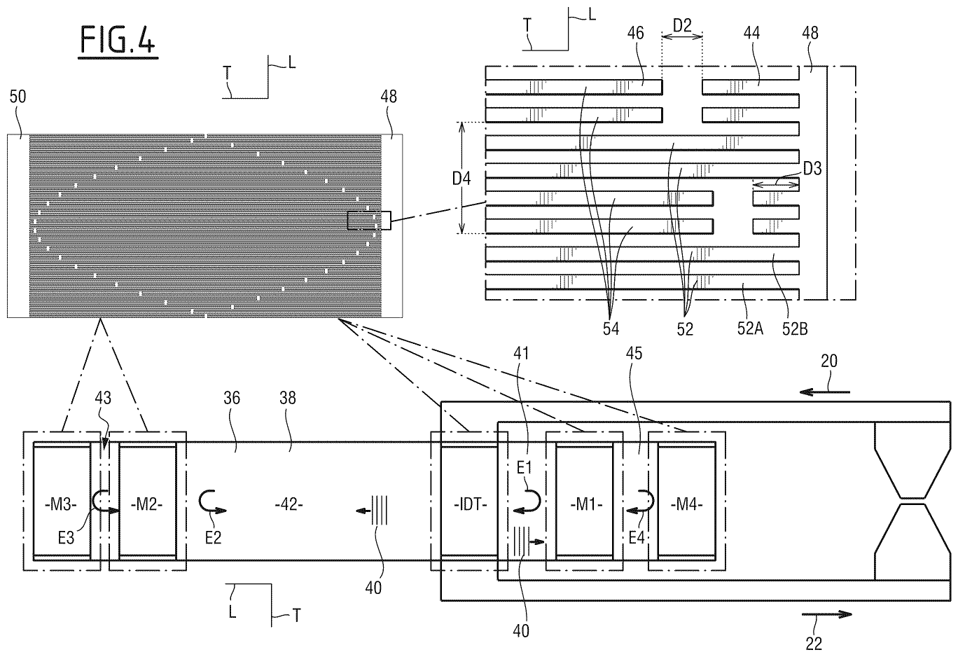

An installation 10 will now be described with reference to FIG. 3.

The installation 10 comprise a device 12 (equivalent to the device 1A in FIG. 1) according to the invention, exposed to a monitored environment, for example buried in a soil 14.

The installation 10 advantageously comprises a system 18 (equivalent to the system 13A in FIG. 1), for example located above the soil 14 and adapted for emitting an electrical signal 20 towards the device 12 and for receiving an electrical response signal 22 from the device via a line 24.

As a variant (not shown), the installation 10 may comprise several devices analogous to the shown one, and/or several systems analogous to the shown system 18.

The soil 14 is for example saturated with water and contains the BTEX component, for example toluene, which is to be detected by the installation 10. The BTEX component is for example carried, or pushed, by the water present in the soil 14. It is assumed here that the BTEX component and water constitute a miscible or immiscible water-liquid phase 23. The word “phase” here does not mean that the BTEX component is miscible with the water.

In the example shown, the installation 10 is advantageously able to detect another chemical component, for example a BTEX one distinct from toluene, or for another analyte like, for instance, H₂S.

According to other variants, the installation 10 may be able to detect more than two distinct chemical components.

By “detect a chemical component”, it is meant that the installation 10 is adapted to provide information showing the presence of said chemical component next to the device 12, preferably in a quantitative or semi-quantitative manner.

The device 12 is for example meant to stay in the soil 14 and is adapted to send information via the response signal 22 when interrogated by the system 18.

The device 12 for example comprises an enclosure 26 permeable to the liquid phase 23, and a sensor 28 located in the enclosure.

As a variant (not shown), the sensor 28 is wireless, for example configured as a cooperative target to Ground Penetrating RADAR (known in itself as GPR). The sensor then includes an antenna (not shown).

The enclosure 26 for example comprises a grid 34 adapted to let the liquid phase 23, including the BTEX component, flow into the enclosure.

The grid 34 is advantageously located in an upper part of the enclosure 26.

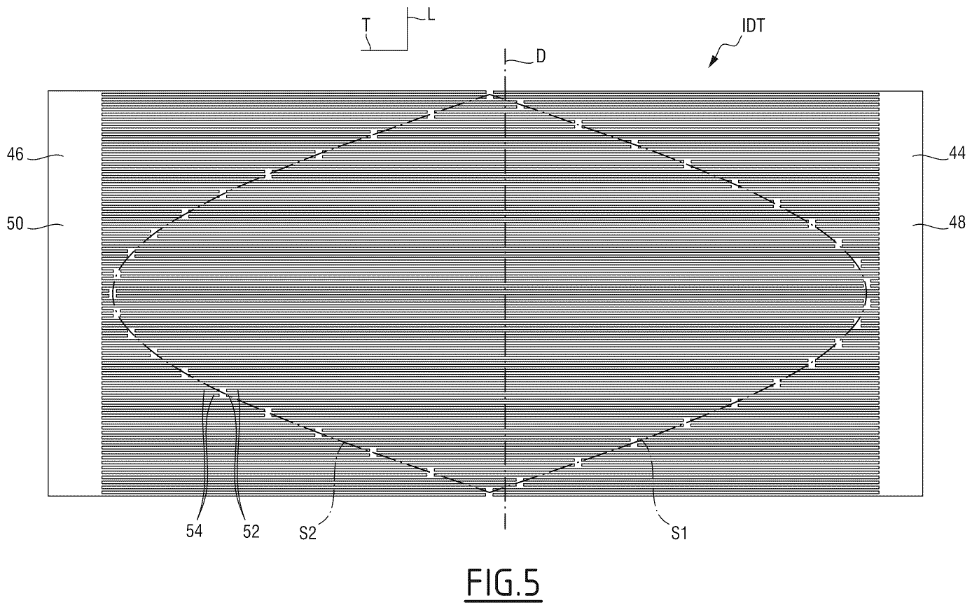

The sensor 28 (FIGS. 3 and 4) is for example a SAW sensor.

As a variant (not shown), the sensor 28 is a BAW or an SPR sensor.

In the example, the sensor 28 comprises a piezoelectric substrate 36 having a surface 38 extending in a longitudinal direction L, and an interdigitated transducer IDT located on the surface 38 and adapted to convert the signal 20 into surface acoustic waves 40 in the longitudinal direction L by piezoelectric effect.

The sensor 28 comprises a first mirror M1 located on the surface 38 and adapted for receiving a first part of the surface acoustic waves 40 and for producing a first echo E1 towards the transducer IDT by mechanical reflection and/or re-emission of said first part of the surface acoustic waves. The sensor 28 comprises at least a first layer 41 of said polymer located on the surface 38 between the transducer IDT and the first mirror M1, the polymer being adapted to react with the BTEX component so as to modify a travel speed of the first echo E1 along the first layer 41.

The sensor 28 advantageously comprises a second mirror M2, and a third mirror E3 located on the surface 38 and adapted for receiving a second part and a third part of the surface acoustic waves 40 and producing a second echo E2 and a third echo E3 towards the transducer IDT by mechanical reflection or re-emission of said second part and third part of the surface acoustic waves.

The sensor 28 advantageously comprises at least a second layer 42 of said polymer located on the surface 38 between the transducer IDT and the second mirror M2, and a third layer 43 of the polymer located on the surface 38 between the second mirror M2 and the third mirror M3.

In a particular embodiment, the sensor 28 further comprises a fourth mirror M4 (only shown in FIG. 4) located on the surface 38 and adapted for receiving a fourth part of the surface acoustic waves and producing a fourth echo E4 towards the transducer IDT by mechanical reflection and/or re-emission of said a fourth part of the surface acoustic waves.

The sensor 28 advantageously comprises a fourth layer 45 comprising a metal and/or a second polymer, the fourth layer being located on the surface 38 between the first mirror M1 and the fourth mirror M4.

The sensor 28 is advantageously configured to form a reflective delay line, creating four echoes E1 to E4 in the example.

In the example, the first layer 41, the second layer 42 and the third layer 43 are of the same nature, providing redundant information.

The second polymer may be polyisobutene (PIB).

In a particular embodiment (not shown), the first echo E1 may serve as a reference for the other echoes.

In other embodiments (not shown), depending on the nature of the layers 41, 42, 43, 45, and their number, the echoes may provide information about a drift due to temperature, and/or the detection of another chemical component (in case the second polymer is different from the polymer), and/or redundancy in the detection of the BTEX component or of the other element.

Depending on the number of mirrors and the nature of the layers on the surface 38 in between the mirrors and the transducer IDT, other relative positions are possible for these elements.

The sensor 28 is advantageously configured so that the surface acoustic waves 40, along the first layer 41 and advantageously the layers 42, 43 and 45, comprise Love waves.

This allows maximizing energy confinement within the sensor 28, in order to maximize its gravimetric sensitivity.

The substrate 36 is advantageously made of stoichiometric lithium tantalate (LiTaO₃), for example YXl/36°, although any pseudo-shear wave generating crystallographic orientation (e.g. YXl/42°) will meet the requirements of a sensor operating in liquid.

The substrate 36 is adapted for propagating a pseudo-shear wave which can be confined to the surface 38 either by metalizing the free surface in order to slow down the wave and hence confine energy to the surface through the conducting boundary condition, and/or coating the surface with a polymer whose acoustic velocity is slower than the shear wave in the piezoelectric substrate bulk.

The substrate 36 is for example a rectangular plate, with a length of for example 10 mm in the longitudinal direction L, and a width of for example 3 mm in a transverse direction T perpendicular to the longitudinal direction L. The substrate 36 for example has a thickness comprised between 300 and 500 μm, thick enough to avoid interaction of the surface acoustic wave with the opposite side of the wafer.

In a particular embodiment, the transducer IDT, the first mirror M1, the second mirror M2, the third mirror M3 and the fourth mirror M4 are structurally analogous to each other.

For example, the second mirror M2 and the third mirror M3 (if present) are on one side of the transducer IDT in the longitudinal direction L, while the first mirror M1 and the fourth mirror M4 (if present) are on the other side. For example, the third mirror M3 is further away from the transducer IDT than the second mirror M2, and the fourth mirror M4 is further away from the transducer than the first mirror M1.

Advantageously, the mirrors are located along the longitudinal direction L so that the echoes they create are received successively by the transducer IDT and are easy to isolate from each other, with for example at least 0.5p s between each other.

The transducer IDT is adapted to convert the first echo E1, and in the example the second echo E2, the third echo E3 and the fourth echo E4, into the response signal 22 by piezoelectric effect.

In the example, the transducer IDT, the first mirror M1, the second mirror M2, the third mirror M3 and the fourth mirror M4 are structurally analogous to each other (though not represented in the same way in FIG. 3) since electrical re-emission is used as a reflection method rather than mechanical reflection at the low (sub-500 MHz) frequencies considered here. Therefore, only the transducer IDT will be described hereafter.

As a variant (not shown), the mirrors M1 to M4 may differ from the transducer IDT, and/or may differ from each other, for example by tuning the number of electrodes in each mirror so that the returned power is the same for all echoes.

The transducer IDT is advantageously formed by a single patterned layer of metal, for example aluminum, or gold if resistance to corrosion is desired.

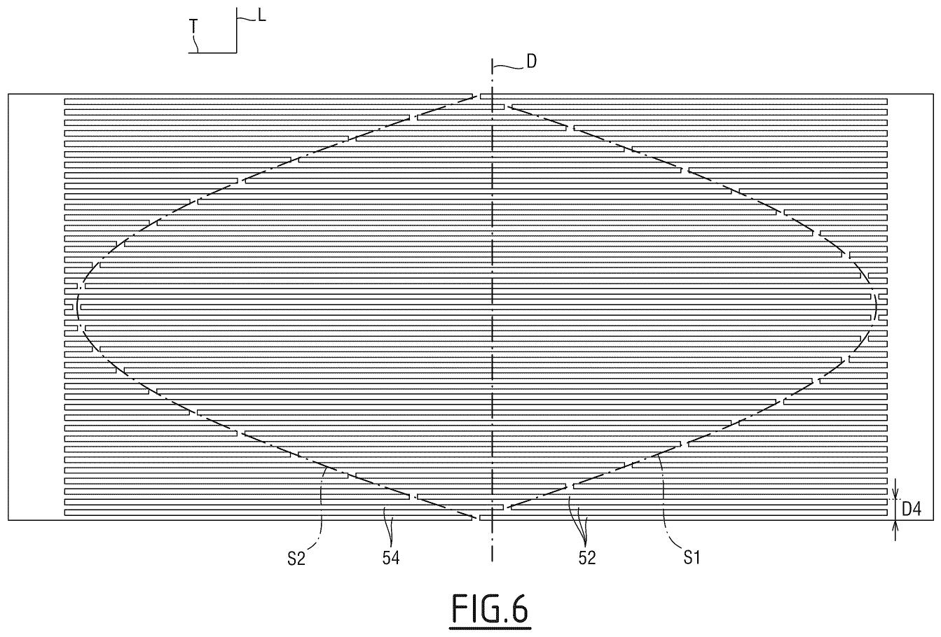

The transducer IDT comprises two electrodes 44, 46 (FIGS. 4 and 5) respectively comprising two bases 48, 50 extending longitudinally and spaced apart transversely from each other. The electrodes 44, 46 respectively comprise two sets of fingers 52, 54 protruding transversely from one of the bases 48, 50 towards the other one, and vice-versa.

The transducer IDT is interdigitated, as the fingers 52 from one set alternate with fingers 54 of the other set along a median line D parallel to the longitudinal direction L.

In the example, each of the fingers 52 of one of the two sets faces a corresponding finger 54 of the other set transversely.

The fingers 52, 54 are separated transversely by a distance D2 (FIG. 4) of for example 10 μm. The shortest fingers have a length D3 in the transverse direction T of for example 10 μm.

In the example shown in FIGS. 4 and 5, each of the fingers 52, 54 is a split finger. Each of the fingers is split in two half-fingers 52A, 52B. For example, the width of the half-fingers in the longitudinal direction L is equal to the distance between the half-fingers.

In the example, the transducer IDT has a sine shaped apodization, as, in each of the two sets of fingers 52, 54, one finger out of two in the longitudinal direction L defines a first portion of sinusoid S1, and the other finger out of two defines a second portion of sinusoid S2. Each of the first portion of sinusoid S1 and the second portion of sinusoid S2 for example corresponds to a half-period. The fingers forming the first portion of sinusoid S1 or the second portion of sinusoid S2 defines a longitudinal period D4 of for example 41 μm.

The fingers 52, 54 and the bases 48, 50 have a thickness, perpendicularly to the substrate 36, of for example 0.5 μm.

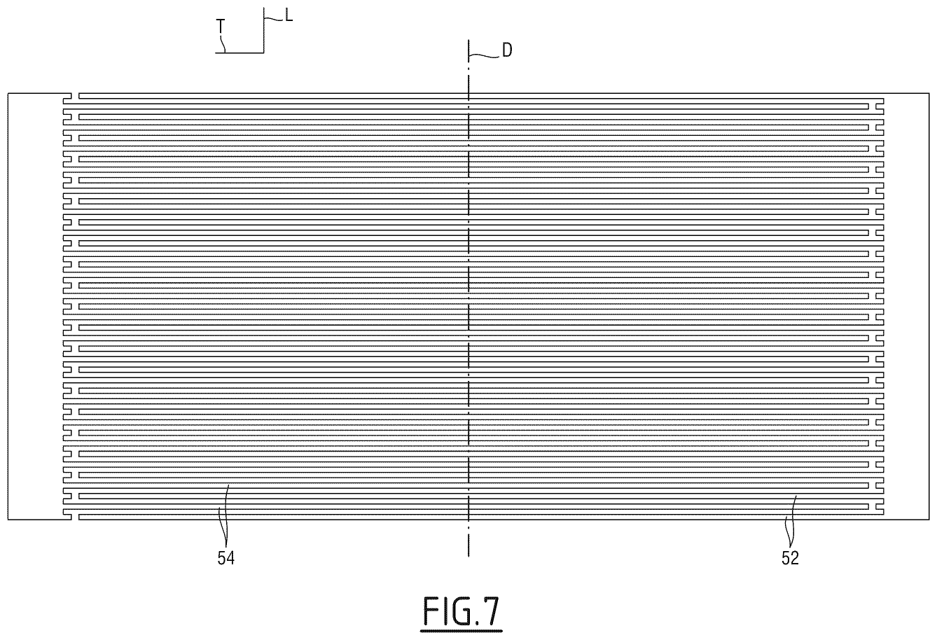

As a variant, shown in FIG. 6, the fingers 52, 54 are not split. The width of the fingers 52, 54 is for example equal to the distance between two consecutive fingers in the longitudinal direction L.

According to another variant, shown in FIG. 7, the transducer IDT has a simple apodization, as each of the sets of fingers 52, 54 includes long fingers and short fingers alternating longitudinally.

The echoes are advantageously stronger with the split finger and sine shaped apodization structure.

The main mechanisms for transmitting a wave back from a mirror towards the IDT are mechanical reflection and re-emission. The former effect is induced by the acoustic velocity variation induced on the one hand by mechanical mass loading reflection and on the other hand by electrical boundary condition changes as the wave propagates from free space to an area metallized when patterning an electrode. It has been noticed that these two effects exhibit opposite sign in the case of a substrate in lithium niobate and add-up in the case of lithium tantalate. In re-emission, a current is induced in the mirror electrodes by the incoming acoustic wave, inducing stress in the crystalline lattice of the substrate 36 and hence a new acoustic wave propagating in both directions away from the mirror structure patterned as IDTs themselves. This was observed to yield the strongest echo and hence lowest insertion losses in the reflection coefficient.

The polymer layer thickness allows optimizing the gravimetric sensitivity through acoustic wave confinement in the polymer guiding the wave in a Love-mode approach.

The layers 41, 42, 43, 45 are advantageously adapted for guiding and confining the acoustic waves and their echoes within the substrate 36.

The system 18 is advantageously adapted for using the response signal 22 in order to detect the BTEX component.

As a variant, the system 18 is adapted to send the response signal 22 to a distant computer (not shown) adapted for using the response signal.

The center frequency of the signal 20 is for example comprised between 100 and 500 MHz.

The operation of the installation 10 derives from its structure and will now be described in order to illustrate a method for detecting a BTEX component according to the invention.

In the example, the aim is to detect the BTEX component in the water-miscible or immiscible liquid phase in the soil 14 saturated with water.

For example, the signal 20 is emitted by the system 18, then received by the transducer IDT and converted into the surface acoustic waves 40 in the longitudinal direction L.

The first part of the surface acoustic waves 40 is received by the first mirror M1. The first mirror M1 produces the first echo E1 towards the interdigitated transducer IDT by mechanical reflection and/or re-emission of said first part of the surface acoustic waves. The first layer 41 ensures that the first part of the surface acoustic waves and the first echo E1 can travel along the substrate 36.

The second part and the third part of the surface acoustic waves 40 are received by the second mirror M2 and the third mirror M3, producing the second echo E2 and the third echo E3 towards the transducer IDT by mechanical reflection or re-emission of said second part and third part of the surface acoustic waves 40.

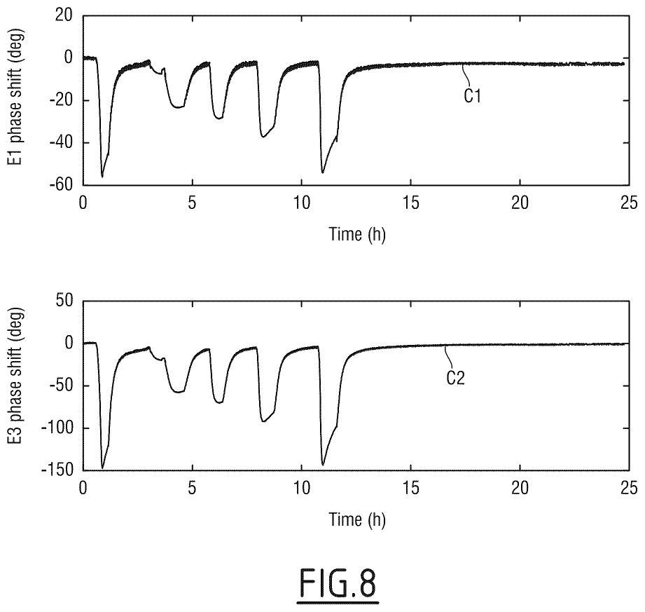

In the example, the enclosure 26 allows the liquid phase 23 surrounding the device 12 to be in contact with the first layer 41 of polymer. In case the BTEX component is present in the liquid phase 23, the BTEX component interacts with the polymer and modifies the travel speed of acoustic waves along the first layer 41 and the third layer 43, which affects the first echo E1 and the third echo E3 as shown in FIG. 8.

The first echo E1, the second echo E2 and the third echo E3 are converted by the interdigitated transducer IDT into at least part of the response signal 22. The response signal 22 is representative of the first echo E1, the second echo E2 and the third echo E3.

The response signal 22 is then used in order to detect the BTEX component, and advantageously the other chemical component.

Thanks to the above features, the device 12 allows detection of BTEX components with good sensitivity and selectivity.

### Example of Synthesis and Deposition of the Polymer

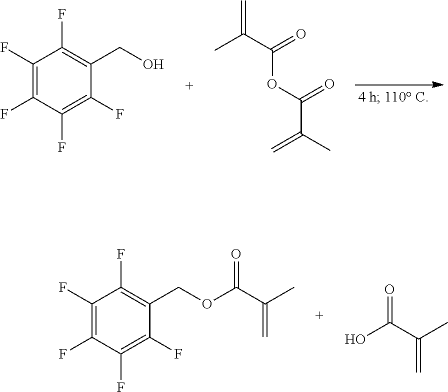

10 grams of 2,3,4,5,6-pentafluorobenzylalcohol (50.5 mmol) are reacted in 7 mL (47 mmol) of methacrylic anhydride for 4 hours at 110° C.

The obtained crude oil is thoroughly washed with a solution of aqueous potassium carbonate 10% w/v. The pure compound is obtained by distillation of this mixture (Bp: 118° C. at 40 mbar).

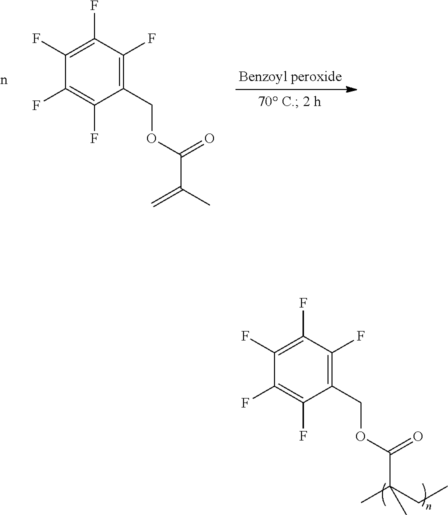

3 mL of (2,3,4,5,6-pentafluorobenzyl)methacrylate are heated for 2 hours at 70° C. with 40 mg of benzoyl peroxide as catalyst to afford the corresponding polymer. The transparent block is dissolved in 20 mL of dichloromethane and the solution is added dropwise in 200 mL of ethanol. The poly(2,3,4,5,6-pentafluorobenzyl methacrylate) (pPFBMA) is filtered off as a white powder.

The number of repetitive units was determined to be of 50 by deep analysis of the ¹H NMR spectrum of the pPFBMA.

The lithium tantalate piezoelectric substrate 36 of the reflective delay line acoustic sensor fabricated by patterning Al interdigitated electrodes and mirrors is thoroughly washed with dichloromethane, acetone, ethanol and then propan-2-ol. The surface is activated for 5 min by an anisotropic oxygen plasma. A monolayer of TiPrime (adhesion promoter) is deposited by spin coater (speed 3000 rpm with an acceleration of 900 rpm² during 30 s). A solution of 15% w/v pPFBMA in 1,2-dichloroethane is then deposited with the same spin-coating conditions in order to obtain a 600 to 1000 nm thick layer of polymer.

The functionalized acoustic sensors are then baked for 2 h at 110° C.

### Experimental Detection of BTEX

The SAW sensor 28 as described above, functionalized with layers 41, 42 and 43 of pPFBMA, with a thickness of 850 nm, was exposed, to a water solution with different concentrations of toluene, each toluene exposure was followed by rinsing with water. The phase variation was monitored with a sensor working at a frequency of 100 MHz as a function of the duration of exposition.

Results are shown in FIG. 8, where the phase shift (in degrees) of the first echo E1 (top of FIG. 8) and the phase shift of the third echo E3 (bottom) are represented as a function of time (in hour).

φ=2π f τ, where f is the sensor center frequency and τ the time delay of the echoes, 800 ns for the first echo E1 and 2400 ns for the third echo E3, leading to the differential measurement dφ=2π f dτ, with dτ the time delay difference between echoes.

The phase shift is proportional to the toluene concentration and to the acoustic delay, with echo E3 returned by a mirror located at three times the delay of echo E1.

The experiment demonstrates the capability of the sensor to efficiently detect toluene in the water solution. The measurement was performed in a wired configuration, with a Rohde & Schwarz ZVC8 vector network analyzer. The time domain response of the sensor was deduced from frequency domain measurement by the network analyzer, by computing the inverse Fourier transform and selecting the phase at the returned power maximum location.

The sequence of exposition in terms of concentration of toluene in water was as follows:
1) 0.19 g·L⁻¹
2) 0.05 g·L⁻¹
3) 0.12 g·L⁻¹
4) 0.14 g·L⁻¹
5) 0.19 g·L⁻¹

The concentrations were deduced from UV absorption of the solution around 260 nm.

When the SAW sensor 28 was exposed to a toluene-water solution, we observed a strong decrease of the phase. The phase shift was proportional to the toluene concentration. Then a rinsing with a water solution led to the initial baseline (i. e. no phase shift).

In this experiment, a concentration of 0.19 g/l toluene in water was injected between 0.5 and 1 h following a baseline in water, then water was injected to return to this baseline level, demonstrating the reversibility of the absorption of toluene by the sensing layer. At 2.5 h, a concentration of 0.05 g/l was injected, followed by an injection of 0.12 g/l before rinsing back in pure water at 5 h to return to baseline. Another series of three increasing concentrations of 0.14 g/1l, 0.15 g/1l and 0.19 g/l from 5.5 to 12 hours were injected with washing in water to return to baseline between each exposure step, until water was used to clean the complete setup from 12 to 25 hours, demonstrating the stability of the polymer layer 41 to long term exposure to water.

The experiment was run in a laboratory setup with minimal temperature variation (less than 1 K over the experiment duration), allowing for a reproducibility analysis of the measurement with the two sensing layers 41 and 42 made of the same polymer layer.

All toluene concentrations in water were measured at the beginning and end of the exposure sequence using UV-Vis absorbance at 261 and 268 nm.

In another practical implementation, the layers 41, 42 and 43 could differ as explained above.

It was also checked that the layers 41 and 42 were not sensitive to the presence of a non BTEX component, such as ethanol. The sensor was exposed to an ethanol-water solution having 10 wt % of ethanol, and no phase shift was measured.

1. A device for detection of a BTEX component in a liquid or gaseous phase comprising a sensor adapted for producing a signal representative of the detection, the sensor comprising at least one layer of a material sensitive to the BTEX component and intended to be in physical contact with the phase, the material comprising a polymer including a sequence of the following formula (I): 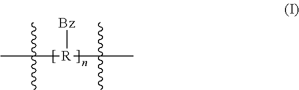
wherein:
R-Bz is a unit repeated n times,
n is an integer greater than 10,
R is an organic group, and
Bz is an at least partly substituted benzyl group of the following formula (Bz): 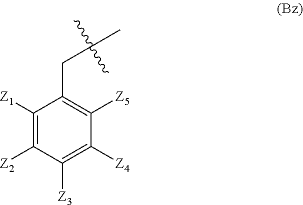
wherein:
at least three independently selected ones among Z1, Z2, Z3, Z4 and Z5 are fluorine atoms, and
the at most two others among Z1, Z2, Z3, Z4 and Z5 are selected among hydrogen, halogen atoms, and C₁ to C₂ alkyl groups.

2. The device according to claim 1, wherein Z1, Z2, Z3, Z4 and Z5 are fluorine atoms.

3. The device according to claim 1, wherein the unit R-Bz has the following formula (II): 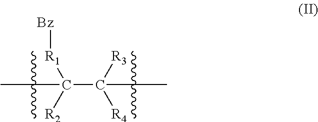
wherein:
R1 is selected from the groups —CH₂—, —C₂H₄— and —C(O)O—, and
each of R2, R3, R4 is independently chosen from hydrogen and C₁ to C₆ alkyl groups.

4. The device according to claim 3, wherein R1 is —C(O)O—.

5. The device according to claim 4, wherein R2 is —CH₃, and R3 and R4 are hydrogen.

6. The device according to claim 4, wherein R2, R3 and R4 are hydrogen.

7. The device according to claim 1, wherein the layer extends on a surface of the sensor and has a thickness perpendicularly to the surface, said thickness being comprised between 600 and 1000 nm.

8. The device according to claim 1, wherein the sensor is a bulk acoustic wave sensor or a surface plasmon resonance sensor.

9. The device according to claim 1, wherein the sensor is a surface acoustic wave sensor.

10. The device according to claim 9, wherein the sensor comprises:
a piezoelectric substrate comprising lithium tantalate, the substrate having a surface extending in a longitudinal direction,
an interdigitated transducer located on the surface for receiving an electrical signal and sending an electrical response signal, the interdigitated transducer being adapted to convert the signal into surface acoustic waves in the longitudinal direction,
at least a first mirror located on the surface and adapted for receiving a first part of the surface acoustic waves and producing a first echo towards the interdigitated transducer by mechanical reflection and/or re-emission of said first part of the surface acoustic waves, and
at least a first layer comprising the polymer, the first layer being located on the surface between the transducer and the first mirror, and being adapted for interacting with the BTEX component so as to modify a travel speed of the first echo along said first layer,
the transducer being adapted to convert the first echo into at least part of the response signal.

11. The device according to claim 10, wherein the sensor further comprises:
a second mirror located on the surface and adapted for receiving a second part of the surface acoustic waves and producing a second echo towards the transducer by mechanical reflection or re-emission of said second part of the surface acoustic waves,
a second layer of a metal, a polymer, or a metal and a polymer, located on the surface between the transducer and the second mirror,
a third mirror located on the surface and adapted for receiving a third part of the surface acoustic waves and producing a third echo towards the transducer by mechanical reflection and/or re-emission of said third part of the surface acoustic waves (40), and
a third layer of a metal, a polymer, or a metal and a polymer located on the surface between the second mirror and the third mirror,
the transducer being adapted for receiving the second echo and the third echo and converting the second echo and the third echo into at least part of the response signal.

12. The device according to claim 10, wherein the transducer and the first mirror comprise aluminum.

13. The device according to claim 10, wherein the transducer, the first mirror, or the transducer and the first mirror is/are interdigitated transducer(s) having split-fingers extending in a transverse direction perpendicular to the longitudinal direction.

14. The device according to claim 10, wherein the transducer, the first mirror, or the transducer and the first mirror is/are interdigitated transducer(s) with sine shaped apodization.

15. A method for detecting a BTEX component in a liquid or gaseous phase, comprising the following steps:
obtaining a device according to claim 1,
allowing physical contact between said layer and the phase,
producing a signal representative of the detection, and
receiving and interpreting the signal.
